(19) United States
(12) Patent Application Publication
(10) Pub. No.: US 2003/0085207 A1
(43) Pub. Date: May 8, 2003

(54) Inert-gas mixture for laser welding of aluminum materials

(76) Inventors: Bernd Hilderbrandt, Toenisvorst (DE); Wolfgang Schagun, Kempen (DE)

Correspondence Address: CONNOLLY BOVE LODGE & HUTZ LLP, 1220 MARKET STREET, P.O. BOX 2207, WILMINGTON, DE, 19899, US

(21) Appl. No.: 10/322,156

(22) Filed: Dec. 18, 2002

Related U.S. Application Data
(62) Division of application No. 09/740,092, filed on Dec. 19, 2000.

(30) Foreign Application Priority Data
Dec. 21, 1999 (DE) 199 61 679 3

(51) Int. Cl. B23K 26/20

(52) U.S. Cl. 219/121.64; 252/372

(57) ABSTRACT

The novel inert gas mixture for the laser welding of aluminum materials has a proportion of 45-70% of nitrogen (N₂) by volume, the remainder being helium (He).

### CROSS-REFERENCE TO RELATED APPLICATION

This application is a division of U.S. patent application Ser. No. 09/740,092, filed Dec. 19, 2000.

### BACKGROUND OF INVENTION

The invention relates to an inert-gas for laser welding of aluminum materials.

With the helium inert gases which have normally been used until now for the laser welding of aluminum materials, metal vapor plasmas occur during the welding from being input, so that the welding performance is reduced by unsatisfactory burning-in and, furthermore, metal vapor is formed in an uncontrolled manner which causes disturbances in the sensor systems used for monitoring the welding process.

### SUMMARY OF INVENTION

The invention is based on the object of providing an inert-gas mixture for laser welding of aluminum materials, which ensures improved welding performance with optimum welding quality.

The object is achieved by an inert-gas mixture which has a proportion of 30 to 70% by volume of N₂, and the rest is He.

### DETAILED DESCRIPTION

An inert gas mixture which has been successfully tested in practice for laser welding of aluminum materials contains 45-60% nitrogen, and the rest is helium.

Welding tests using the inert-gas mixture according to the invention for laser welding of aluminum materials have led to good results, and thus to optimized welding performance/quality, both in terms of improving the burning-in behavior, and in terms of reducing the uncontrolled formation of metal vapor.

What is claimed is:

1. In a process for laser welding of aluminum materials, the improvement being in that the laser welding is done by use of an inert-gas mixture which contains 30 to 70% by volume of N₂ and the rest being He.

2. In the process of claim 1 herein the N₂ is present in a range of 45-60% by volume.

3. In a process for laser welding of aluminum materials, the improvement being in that the laser welding is done by use of an inert-gas mixture which contains 70% by volume of N₂ and the rest being He.

4. In a process for laser welding of aluminum materials, the improvement being in that the laser welding is done by use of an inert-gas mixture which contains 60% by volume of N₂ and the rest being He.
